(19) United States
(12) Patent Application Publication
(10) Pub. No.: US 2018/0231490 A1
(43) Pub. Date: Aug. 16, 2018

(54) METHOD FOR CALCULATING HEMATOCRIT IN BLOOD, METHOD FOR CALIBRATING BIOCHEMICAL INDEX VALUE IN BLOOD, AND SYSTEM THEREOF

(71) Applicant: DELBio, INC., Taoyuan City (TW)

(72) Inventors: Bo-Jiun SHEN, Taoyuan City (TW); Chi-Yen CHEN, Taoyuan City (TW)

(21) Appl. No.: 15/648,472

(22) Filed: Jul. 13, 2017

(30) Foreign Application Priority Data
Feb. 15, 2017 (TW) 106104836

(51) Int. Cl. G01N 27/327; G01N 15/05

(52) U.S. Cl. CPC G01N 27/3274; G01N 27/3272; G01N 2015/0065; G01N 2015/055; G01N 15/05

(57) ABSTRACT

A method for calculating hematocrit in blood includes: applying a blood sample to a reagent layer on an electrochemical test strip; sequentially applying a first high positive voltage and a second high positive voltage to the blood sample, in which the second high positive voltage is greater than the first high positive voltage, and the first high positive voltage is greater than or equal to 1.0 V; calculating a quantity of electricity corresponding to the period of applying the second high positive voltage; and calculating a hematocrit of the blood sample according to the quantity of electricity.

### RELATED APPLICATIONS

This application claims priority to Taiwan Application Serial Number 106104836, filed Feb. 15, 2017, which is herein incorporated by reference.

### BACKGROUND

### Technical Field

The present disclosure relates to a method for calculating hematocrit in blood, a method for calibrating biochemical index value in blood, and a system thereof.

### Description of Related Art

During the inspection of whole blood, the hematocrit (HCT) in the whole blood often affects inspection values. Take blood glucose as an example, when the hematocrit is large, the glucose concentration of the whole blood will be underestimated. On the contrary, when the hematocrit is small, the glucose concentration of the whole blood will be overestimated. Presently, most of the electrochemical sensors use AC signal to reduce the interference that the hematocrit causes to the blood glucose. However, most of the electrode designs for performing the foregoing approach need four or more than four electrodes. In addition to the electrode designs, the circuit designs of blood glucose meters are also complex because AC and DC signals are used for inspection at the same time.

In addition, if the DC signal is used for the HCT inspection, conventional sensors mostly apply only one voltage signal and the methods of calculating the hematocrit mostly use current value. However, the inspection results of the hematocrit calculated by the methods are extremely inaccurate owing to interferences of reagent layers or other substances in the blood. Furthermore, ifs difficult to control the production processes of the test strips so as to impair the reproducibility of the inspection values.

Accordingly, how to provide a calibration method and a calibration system to solve the above-mentioned problems becomes an important issue to be solved by those in the industry.

### SUMMARY

An aspect of the disclosure is to precisely calculate the hematocrit in a blood sample and calibrate an inspected biochemical index value in the blood sample by using the hematocrit.

According to an embodiment of the disclosure, a method for calculating hematocrit in blood includes: applying a blood sample to a reagent layer on an electrochemical test strip; sequentially applying a first high positive voltage and a second high positive voltage to the blood sample, in which the second high positive voltage is greater than the first high positive voltage, and the first high positive voltage is greater than or equal to 1.0 V; calculating a quantity of electricity corresponding to the period of applying the second high positive voltage; and calculating a hematocrit of the blood sample according to the quantity of electricity.

In an embodiment of the disclosure, the calculating the hematocrit according to the quantity of electricity includes: mapping the quantity of electricity based on a standard quantity of electricity-hematocrit curve to obtain the hematocrit.

In an embodiment of the disclosure, the first high positive voltage is 1.0-2.0 V, and the second high positive voltage is 2.4-4.0 V.

In an embodiment of the disclosure, the applying of the first high positive voltage is continuously performed for a first time period, the applying of the second high positive voltage is continuously performed for a second time period, and the second time period is greater than or equal to the first time period.

In an embodiment of the disclosure, the first time period is 0.1-1.0 second, and the second time period is 1.0-10 seconds.

In an embodiment of the disclosure, an interval period between the first time period and the second time period is 0-10 seconds.

According to another embodiment of the disclosure, a method for calibrating biochemical index value in blood sequentially includes: applying a blood sample to a reagent layer on an electrochemical test strip; applying a low voltage to the blood sample to obtain an original biochemical index value of the blood sample, in which an absolute value of the low voltage is smaller than 1.0 V; applying a first high positive voltage to the blood sample, in which the first high positive voltage is greater than or equal to 1.0 V; applying a second high positive voltage to the blood sample, in which the second high positive voltage is greater than the first high positive voltage; calculating a quantity of electricity corresponding to the period of applying the second high positive voltage; calculating a hematocrit of the blood sample according to the quantity of electricity; and calibrating the original biochemical index value according to the hematocrit.

In an embodiment of the disclosure, the calculating the hematocrit according to the quantity of electricity includes: mapping the quantity of electricity based on a standard quantity of electricity-hematocrit relationship to obtain the hematocrit.

In an embodiment of the disclosure, the calibrating the original biochemical index value according to the hematocrit includes: calculating the hematocrit based on a standard calibration value-hematocrit relationship to obtain a calibration value; and multiplying the original biochemical index value by the calibration value.

In an embodiment of the disclosure, the absolute value of the low voltage is 0.1-0.7 V.

In an embodiment of the disclosure, a time period for which the low voltage is continuously applied is 1.0-10 seconds.

According to another embodiment of the disclosure, a system for calibrating biochemical index value in blood includes an electrochemical test strip and a processor. The electrochemical test strip includes a substrate, a first electrode, a second electrode, and a reagent layer. The first electrode is connected to the positive terminal of the processor, and the second electrode is connected to the negative terminal of the processor. The first electrode is disposed on a surface of the substrate. The second electrode is also disposed on the surface of the substrate. The reagent layer is disposed on the surface of the substrate and partially covers the first electrode and the second electrode. The processor is configured to sequentially applying a low voltage to obtain an original biochemical index value of a blood sample, a first high positive voltage, and a second high positive voltage between the first electrode and the second electrode. An absolute value of the low voltage is smaller than 1.0 V. The first high positive voltage is greater than or equal to 1.0 V, and the second high positive voltage is greater than the first high positive voltage. The processor is further configured to calculate a quantity of electricity corresponding to the period of applying the second high positive voltage, configured to calculate a hematocrit of the blood sample according to the quantity of electricity, and configured to calibrate the original biochemical index value according to the hematocrit.

In an embodiment of the disclosure, the material of the first electrode includes at least one of carbon, palladium, platinum, and gold.

In an embodiment of the disclosure, the material of the second electrode includes at least one of carbon, palladium, platinum, and gold.

In an embodiment of the disclosure, a sum of external resistance of the first electrode and the second electrode is 300-1500 ohm.

In an embodiment of the disclosure, the reagent layer includes an enzyme and an electron mediator.

In an embodiment of the disclosure, a contact area between the second electrode and the reagent layer is 0.8-1.2 mm².

In an embodiment of the disclosure, the first electrode contacts the reagent layer with a first contact area, the second electrode contacts the reagent layer with a second contact area, and a ratio of the second contact area to the first contact area is 1.0-2.0.

In an embodiment of the disclosure, the thicknesses of the first electrode and the second electrode are 6-20 μm.

Accordingly, the method for calculating hematocrit in blood of the disclosure can be used to precisely calculate the hematocrit in the blood sample by sequentially applying two high positive voltages and using the quantity of electricity corresponding to the period of applying the second high positive voltage. The hematocrit obtained by mapping the quantity of electricity based on the standard quantity of electricity-hematocrit curve is precise owing to the standard quantity of electricity-hematocrit curve is very linear. The method and system for calibrating biochemical index value in blood of the disclosure can be used to calibrate the inspected biochemical index value in the blood sample by using the precisely calculated hematocrit. In addition, in the system for calibrating biochemical index value in blood of the disclosure, the electrode design is simple (only two electrodes are required), the approach of applying voltages is simple (only DC voltages are applied), and the inspection time is short. The biochemical index value mentioned in the disclosure can be the blood glucose concentration or the uric acid concentration, or other biochemical index values that will be influenced by the hematocrit.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a system for calibrating biochemical index value in blood according to an embodiment of the disclosure;

FIG. 2 is a cross-sectional view of the electrochemical test strip taken along line 2-2 in FIG. 1;

FIG. 3 is a flow chart of a method for calculating hematocrit in blood according to an embodiment of the disclosure;

FIG. 4 is a voltage-time curve diagram of applying a first high positive voltage and a second high positive voltage according to an embodiment of the disclosure;

FIG. 5 is a current-time curve diagram of applying a first high positive voltage and a second high positive voltage according to an embodiment of the disclosure;

FIG. 6 is a quantity of electricity-hematocrit curve diagram corresponding to applying a second high positive voltage according to an embodiment of the disclosure;

FIG. 7 is a quantity of electricity-hematocrit curve diagram corresponding to applying a second high positive voltage under the conditions of different sums of external resistance of the first electrode and the second electrode according to an embodiment of the disclosure;

FIG. 8 is a quantity of electricity-hematocrit curve diagram corresponding to applying a second high positive voltage under the conditions of different sums of external resistance with different thicknesses of the first electrode and the second electrode according to an embodiment of the disclosure;

FIG. 9 is a quantity of electricity-hematocrit curve diagram corresponding to applying a second high positive voltage under the conditions of different ratios of contact areas of the first electrode and the second electrode respectively contacting the reagent layer according to an embodiment of the disclosure;

FIG. 10 is a flow chart of a method for calibrating biochemical index value in blood according to an embodiment of the disclosure;

FIG. 11 is a voltage-time curve diagram of applying a low voltage, a first high positive voltage, and a second high positive voltage according to an embodiment of the disclosure;

FIG. 12 is a deviation of biochemical index value-hematocrit test chart calibrated by the method for calibrating biochemical index value in blood; and

FIG. 13 is a calibration value-hematocrit curve diagram according to an embodiment of the disclosure.

Reference will now be made in detail to the present embodiments of the disclosure, examples of which are illustrated in the accompanying drawings. Wherever possible, the same reference numbers are used in the drawings and the description to refer to the same or like parts.

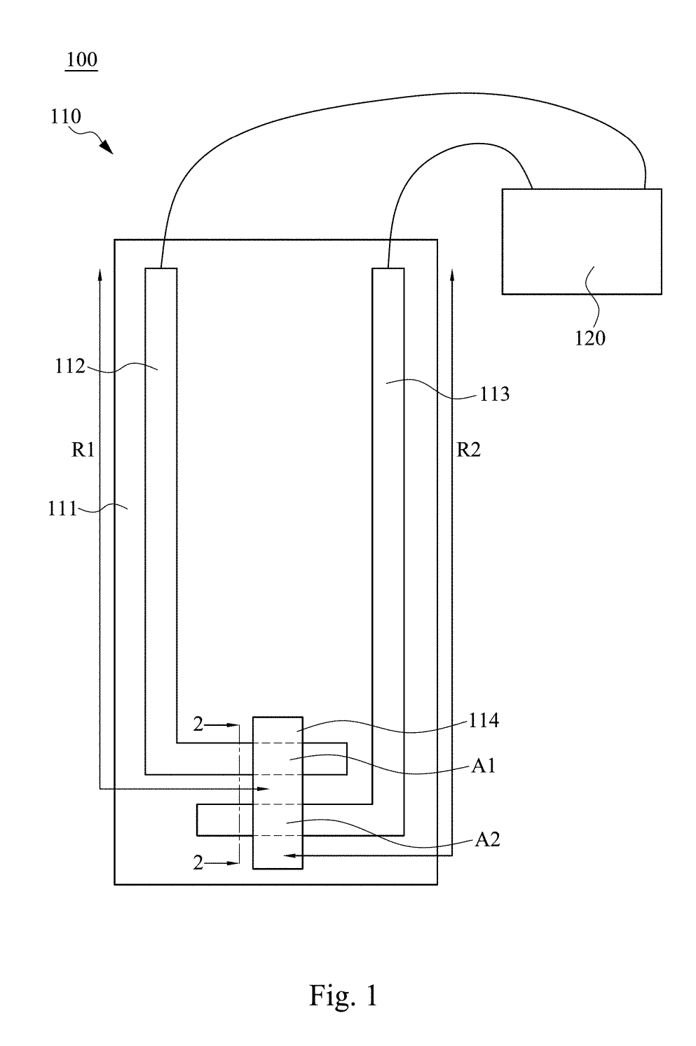

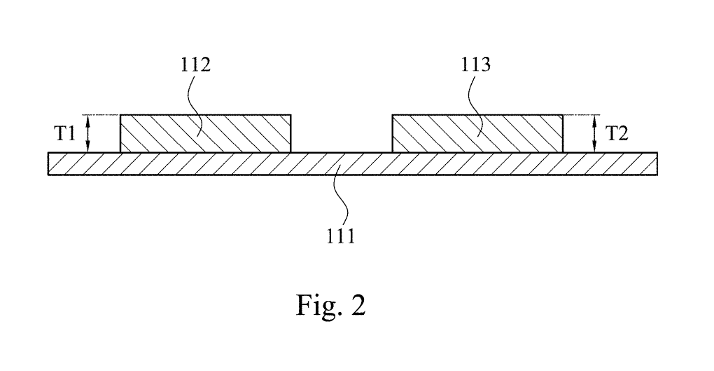

Reference is made to FIG. 1. FIG. 1 is a schematic diagram of a system 100 for calibrating biochemical index value in blood according to an embodiment of the disclosure. As shown in FIG. 1, in the embodiment, the system 100 includes an electrochemical test strip 110 and a processor 120. Reference is made to FIG. 2. FIG. 2 is a cross-sectional view of the electrochemical test strip 110 taken along line 2-2 in FIG. 1. As shown in FIGS. 1 and 2, the electrochemical test strip 110 includes a substrate 111, a first electrode 112, a second electrode 113, and a reagent layer 114. The first electrode 112, the second electrode 113, and the reagent layer 114 are disposed on the same surface of the substrate 111. The reagent layer 114 partially covers the first electrode 112 and the second electrode 113. The processor 120 is electrically connected to the first electrode 112 and the second electrode 113, and is configured to form a potential difference between the first electrode 112 and the second electrode 113 (through the reagent layer 114). In the embodiment, the first electrode 112 is connected to the positive terminal of the processor 120, and the second electrode 113 is connected to the negative terminal of the processor 120.

In some embodiments, the material of the first electrode 112 includes at least one of carbon, palladium, platinum, and gold, but the disclosure is not limited in this regard.

In some embodiments, the material of the second electrode 113 includes at least one of carbon, palladium, platinum, and gold, but the disclosure is not limited in this regard.

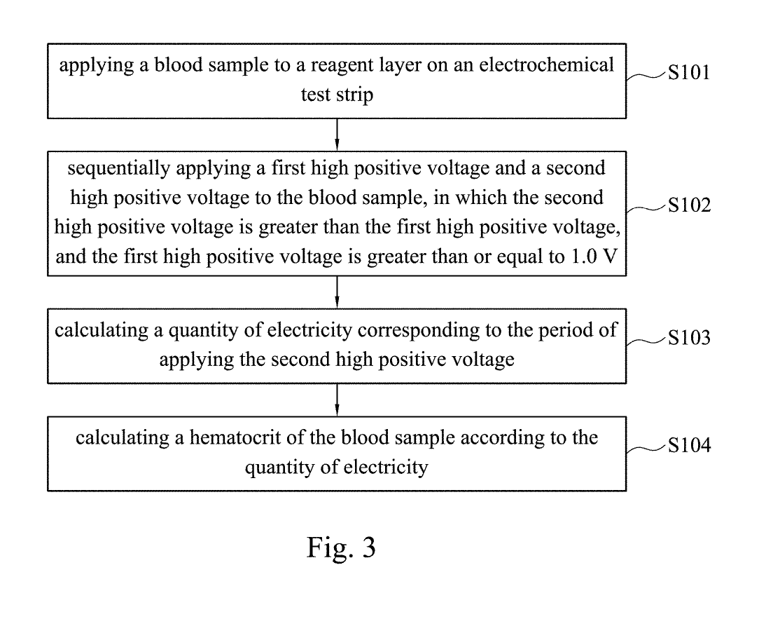

Reference is made to FIG. 3. FIG. 3 is a flow chart of a method for calculating hematocrit in blood according to an embodiment of the disclosure. As shown in FIG. 3, the method for calculating hematocrit in blood of the embodiment can be implemented by using the system 100 shown in FIG. 1. The method for calculating hematocrit in blood of the embodiment includes steps S101-S104.

Firstly, in step S101, a blood sample is applied to a reagent layer 114 on an electrochemical test strip 110.

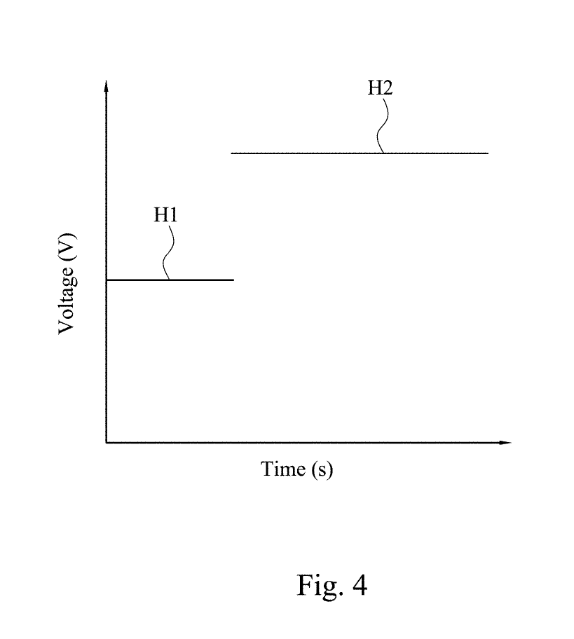

Afterwards, in step S102, the blood sample is sequentially applied with a first high positive voltage and a second high positive voltage, in which the second high positive voltage is greater than the first high positive voltage, and the first high positive voltage is greater than or equal to 1.0 V. Reference is further made to FIG. 4. FIG. 4 is a voltage-time curve diagram of applying a first high positive voltage H1 and a second high positive voltage H2 according to an embodiment of the disclosure.

It should be pointed out that the purpose of forming the potential difference between the first electrode 112 and the second electrode 113 is to catalyze the blood sample on the reagent layer 114 to undergo a chemical reaction, so as to generate an electronic transmission signal (i.e., the so-called current value).

In an example of inspecting blood glucose by using the electrochemical test strip 110, the main ingredients contained in the reagent layer 114 can convert the blood glucose in the blood sample into gluconolactone, and then the electron mediator can be transformed from the oxidation state to the reduction state. By forming the potential difference between the first electrode 112 and the second electrode 113, the reduced state substance can be catalyzed into an oxidation state substance. The substances in the reagent layer 114 include an enzyme that can accelerate the reaction, a buffer solution, an electron mediator, an enzyme stabilizer, a molding agent, a surfactant, or a thickener. The enzyme can be Glucose dehydrogenase (GDH) enzyme or Glucose oxidase (GOD) enzyme.

In an embodiment, the first high positive voltage H1 is 1.0-2.0 V, and preferably 1.2-1.8 V.

In an embodiment, the second high positive voltage H2 is 2.4-4.0 V, and preferably 2.8-3.6 V.

In an embodiment, the applying of the first high positive voltage H1 is continuously performed for a first time period, the applying of the second high positive voltage H2 is continuously performed for a second time period, and the second time period is greater than or equal to the first time period. For example, the first time period is 0.1-1.0 second, and the second time period is 1.0-10 seconds.

As shown in FIG. 4, the applied first high positive voltage H1 and the applied second high positive voltage H2 are constant values, but the disclosure is not limited in this regard.

In addition, in the embodiment, an interval period between the first time period and the second time period is preferably 0 second (i.e., the second high positive voltage H2 is uninterruptedly applied after the first high positive voltage H1). In an embodiment, the interval period between the first time period and the second time period is 0-10 seconds.

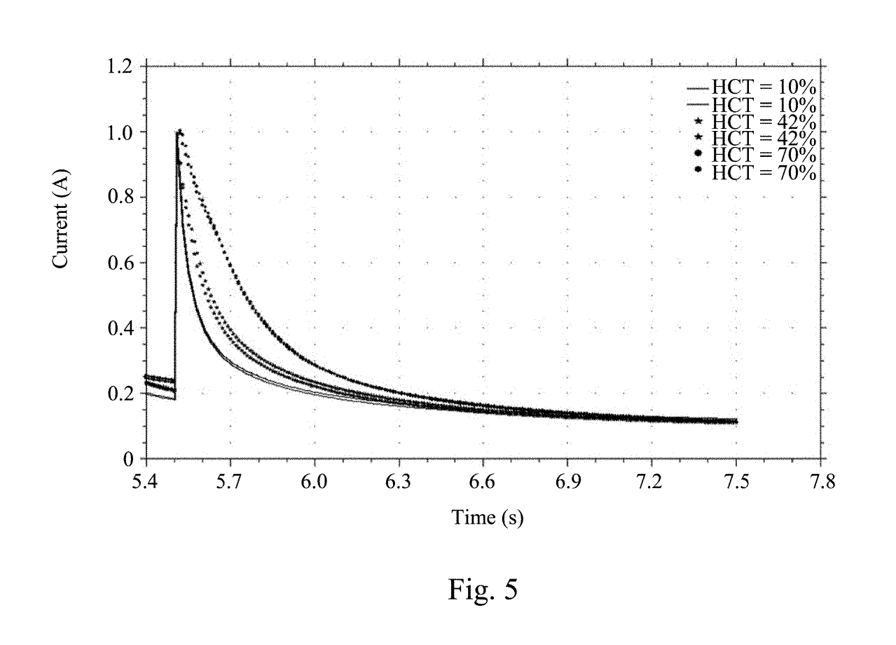

Afterwards, in step S103, a quantity of electricity corresponding to the period of applying the second high positive voltage H2 is calculated. Reference is made to FIG. 5. FIG. 5 is a current-time curve diagram of applying a first high positive voltage H1 and a second high positive voltage H2 according to an embodiment of the disclosure. As shown in FIG. 5, by calculating the areas below the current-time curves (i.e., quantities of electric charge) corresponding to the applying of the second high positive voltage H2, it can be found that area differences exist among different hematocrits HCT.

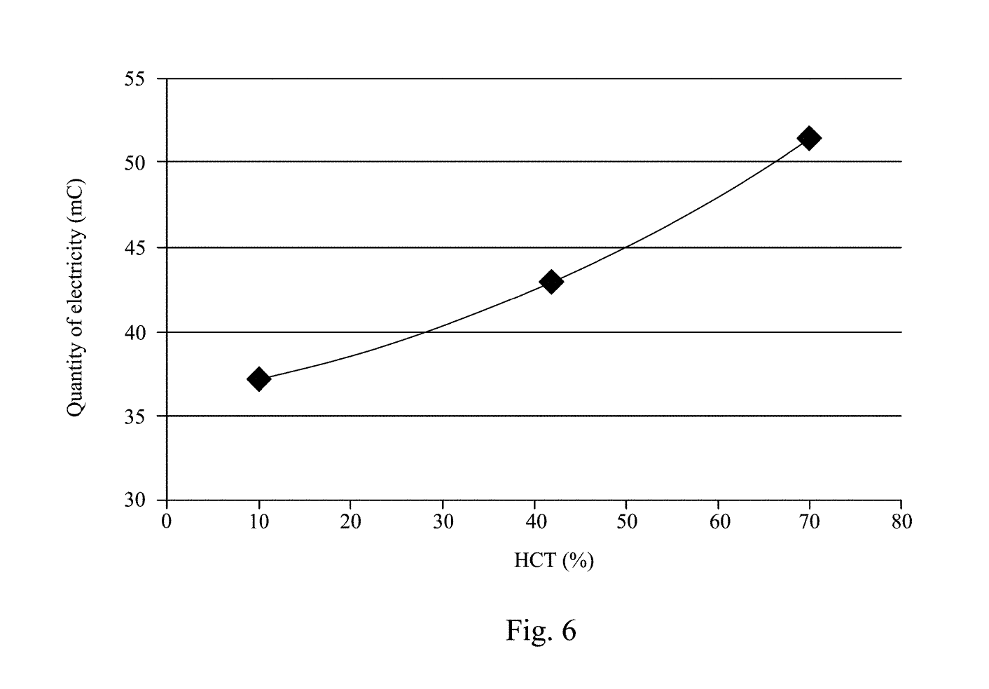

Reference is made to FIG. 6. FIG. 6 is a quantity of electricity-hematocrit curve diagram corresponding to applying a second high positive voltage H2 according to an embodiment of the disclosure. FIG. 6 can be obtained by applying the specific second high positive voltage H2 to several blood samples having different hematocrits HCT. That is, the quantity of electricity-hematocrit curve shown in FIG. 6 can be regarded as a standard quantity of electricity-hematocrit curve corresponding to the applying of the specific second high positive voltage H2.

In other embodiments, the foregoing standard quantity of electricity-hematocrit curve can be transformed to a standard quantity of electricity-hematocrit relationship. Therefore, by substituting a quantity of electricity corresponding to the applying of the specific second high positive voltage H2 into the relationship, the hematocrit HCT corresponding to the quantity of electricity can be obtained.

It should be pointed out that some prior arts only apply a high positive voltage and estimate different hematocrits by using the current values at the end of the applying of the high positive voltage. However, the current-hematocrit curves produced by the prior arts are nonlinear (i.e., a current value may correspond to two hematocrits), so different hematocrits cannot be effectively identified. On the contrary, it can be clearly seen from FIG. 6 of the disclosure that the quantity of electricity corresponding to the applying of the specific second high positive voltage H2 will substantially increase with the increase of the hematocrit HCT, and the relationship between the quantities of electric charge and hematocrits is very linear (substantially positive correlation), so different hematocrits HCT can be effectively identified.

Finally, in step S104, a hematocrit HCT of the blood sample according to the quantity of electricity is calculated. As discussed above, the relationship between the quantities of electric charge and hematocrits is very linear, so as long as the quantity of electricity corresponding to the applying of the specific second high positive voltage H2 is known, a more accurate hematocrit HCT can be obtained by mapping the quantity of electricity based on the quantity of electricity-hematocrit curve diagram shown in FIG. 6.

In an embodiment, steps S102-S104 can be performed by the processor 120, but the disclosure is not limited in this regard.

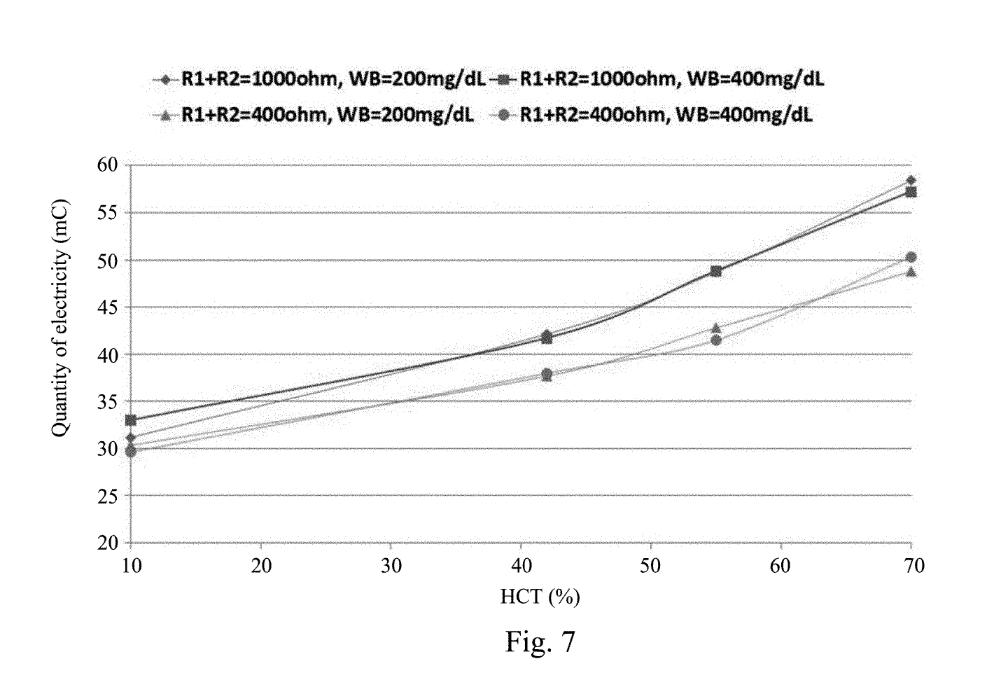

Reference is made to FIG. 7. FIG. 7 is a quantity of electricity-hematocrit curve diagram corresponding to applying a second high positive voltage H2 under the conditions of different sums of external resistance of the first electrode 112 and the second electrode 113 according to an embodiment of the disclosure. As shown in FIGS. 1 and 7, under the conditions of different sums of external resistance (e.g., 400 ohm and 1000 ohm) of the first electrode 112 and the second electrode 113 with different blood glucose concentration WB (e.g., 200 mg/dL and 400 mg/dL), the quantity of electricity-hematocrit curves produced by the applying of the specific second high positive voltage H2 can clearly identify differences among different hematocrits HCT, and the differences are not interfered by the blood glucose concentration WB of the blood samples.

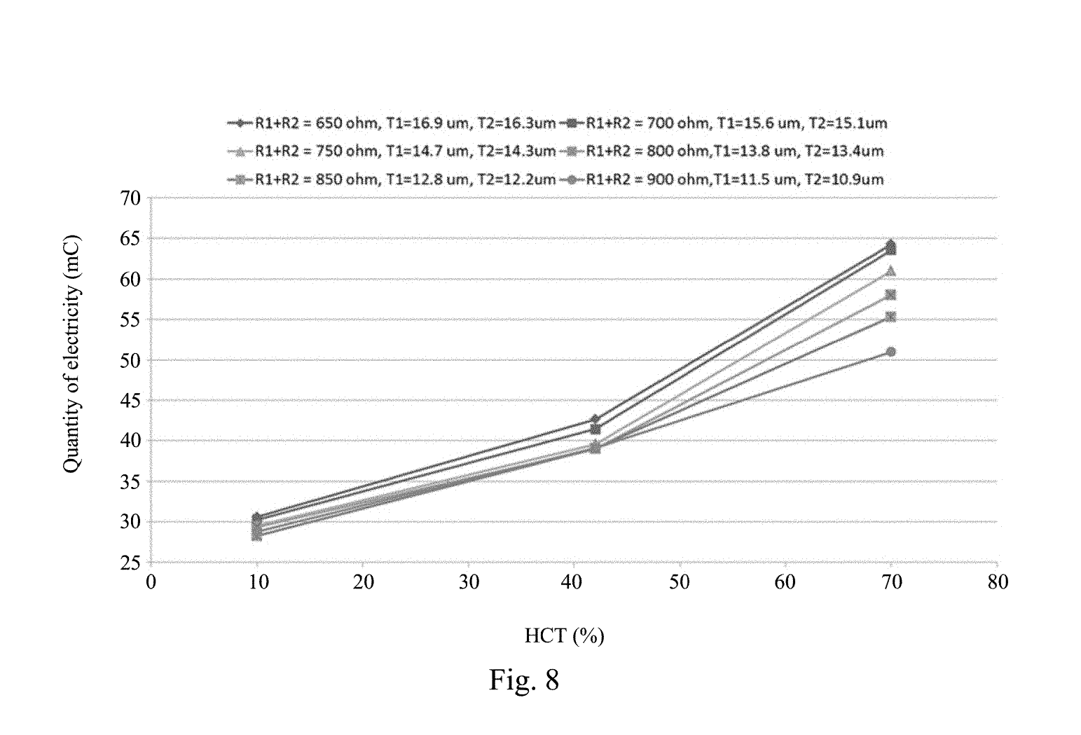

Reference is made to FIG. 8. FIG. 8 is a quantity of electricity-hematocrit curve diagram corresponding to applying a second high positive voltage H2 under the conditions of different sums of external resistance with different thicknesses of the first electrode 112 and the second electrode 113 according to an embodiment of the disclosure. As shown in FIGS. 2 and 8, under the conditions of different sums of external resistance with different thicknesses (the first electrode 112 and the second electrode 113 respectively having a first thickness T1 and a second thickness T2) of the first electrode 112 and the second electrode 113, the quantity of electricity-hematocrit curves produced by the applying of the specific second high positive voltage H2 can clearly identify differences among different hematocrits HCT. In the embodiment, the first thickness T1 of the first electrode and the second thickness T2 of the second electrode are both 6-20 μm, and preferably 10-17 μm.

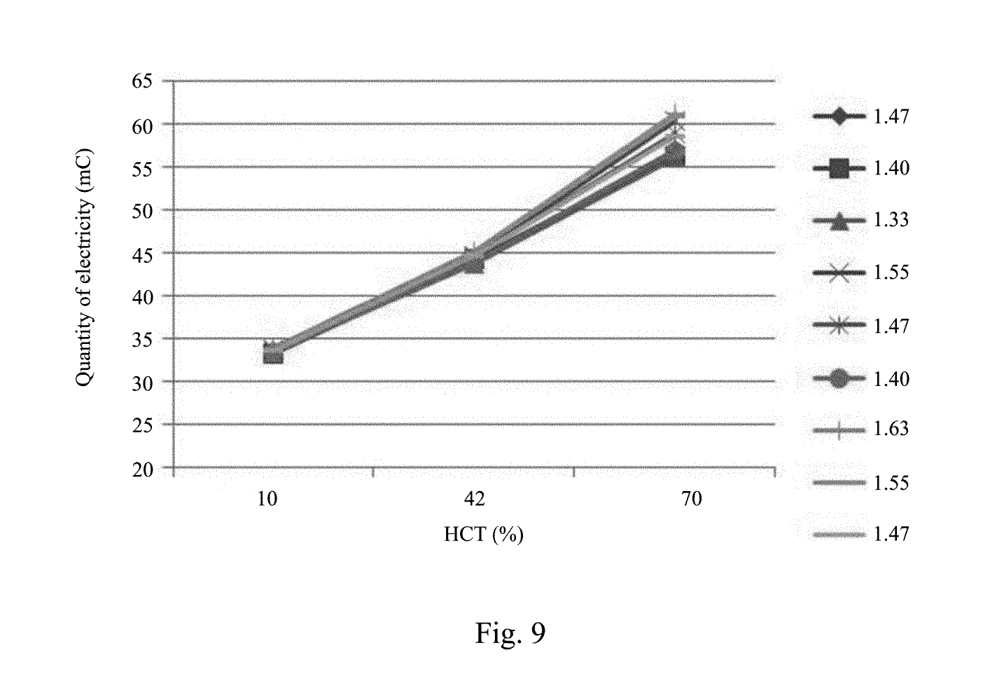

Reference is made to FIG. 9. FIG. 9 is a quantity of electricity-hematocrit curve diagram corresponding to applying a second high positive voltage H2 under the conditions of different ratios of contact areas of the first electrode 112 and the second electrode 113 respectively contacting the reagent layer 114 according to an embodiment of the disclosure. As shown in FIG. 1, the first electrode 112 contacts the reagent layer 114 with a first contact area A1 (i.e., the area of the first electrode 112 covered by the reagent layer 114), and the second electrode 113 contacts the reagent layer 114 with a second contact area A2 (i.e., the area of the second electrode 113 covered by the reagent layer 114). As shown in FIG. 9, under the conditions of different ratios of the first contact area A1 of the first electrode 112 and the second contact area A2 of the second electrode 113, the quantity of electricity-hematocrit curves produced by the applying of the specific second high positive voltage H2 can clearly identify differences among different hematocrits HCT. In the embodiment, a ratio of the second contact area A2 to the first contact area A1 is 1.33-1.63, but the disclosure is not limited in this regard. In practical applications, a ratio of the second contact area A2 to the first contact area A1 can be 1.0-2.0.

In an embodiment, the contact area (i.e., the second contact area A2) of the second electrode 113 contacting the reagent layer 114 is 0.8-1.2 mm².

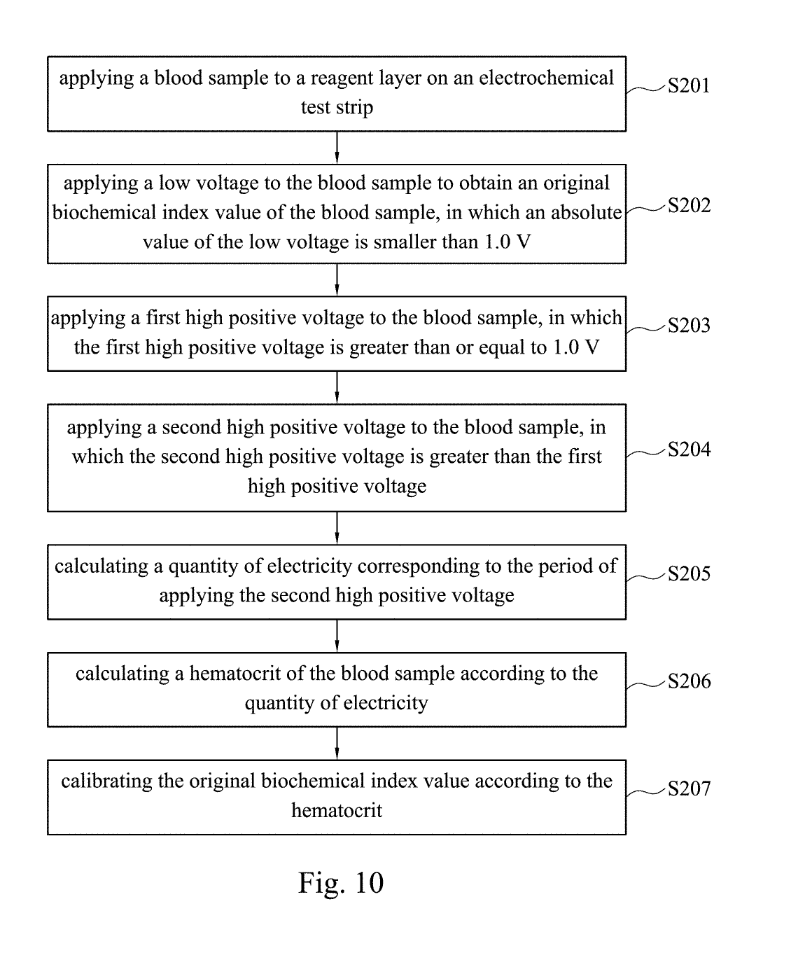

Reference is made to FIG. 10. FIG. 10 is a flow chart of a method for calibrating biochemical index value in blood according to an embodiment of the disclosure. As shown in FIG. 10, the method for calibrating biochemical index value in blood of the embodiment can be implemented by using the system 100 shown in FIG. 1. The method for calibrating biochemical index value in blood of the embodiment sequentially includes steps S201-S207.

Firstly, in step S201, a blood sample is applied to a reagent layer 114 on an electrochemical test strip 110.

In step S202, a low voltage is applied to the blood sample to obtain an original biochemical index value of the blood sample, in which an absolute value of the low voltage is smaller than 1.0 V.

In an embodiment, the absolute value of the low voltage is 0.1-0.7 V, and preferably 0.3-0.5 V.

In an embodiment, a time period for which the low voltage is continuously applied is 1.0-10 seconds.

In step S203, a first high positive voltage is applied to the blood sample, in which the first high positive voltage is greater than or equal to 1.0 V.

In step S204, a second high positive voltage is applied to the blood sample, in which the second high positive voltage is greater than the first high positive voltage.

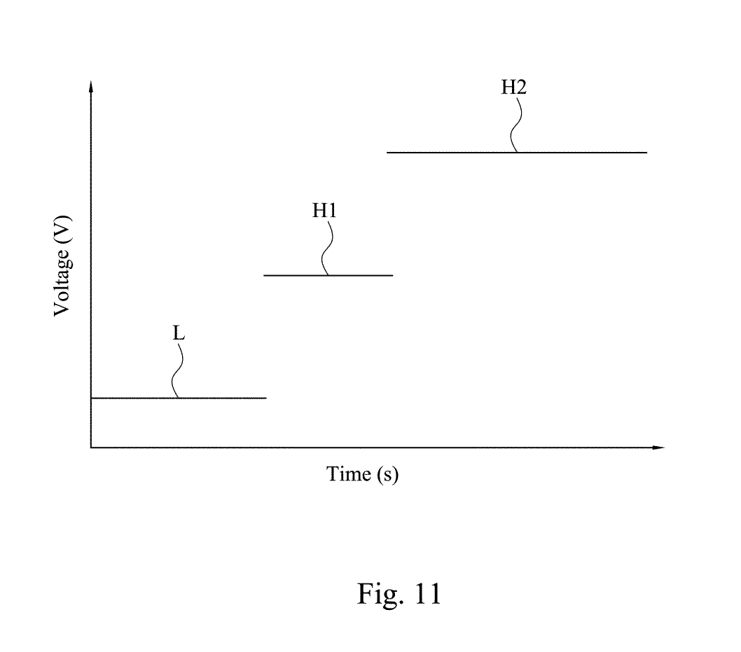

Reference is made to FIG. 11. FIG. 11 is a voltage-time curve diagram of applying a low voltage L, a first high positive voltage H1, and a second high positive voltage H2 according to an embodiment of the disclosure. As shown in FIG. 11, the applied low voltage L, the applied first high positive voltage H1, and the applied second high positive voltage H2 are constant values, but the disclosure is not limited in this regard.

In step S205, a quantity of electricity corresponding to the period of applying the second high positive voltage H2 is calculated.

In step S206, a hematocrit HCT of the blood sample according to the quantity of electricity is calculated.

It should be pointed out that steps S203-S206 regarding calculating the hematocrit HCT in the method for calibrating biochemical index value in blood of the embodiment are substantially the same as steps S102-S104 regarding calculating the hematocrit HCT in the method for calculating hematocrit in blood shown in FIG. 3, so reference can be made to the foregoing descriptions and therefore are not repeated here to avoid duplicity.

Finally, in step S207, the original biochemical index value is calibrated according to the hematocrit HCT.

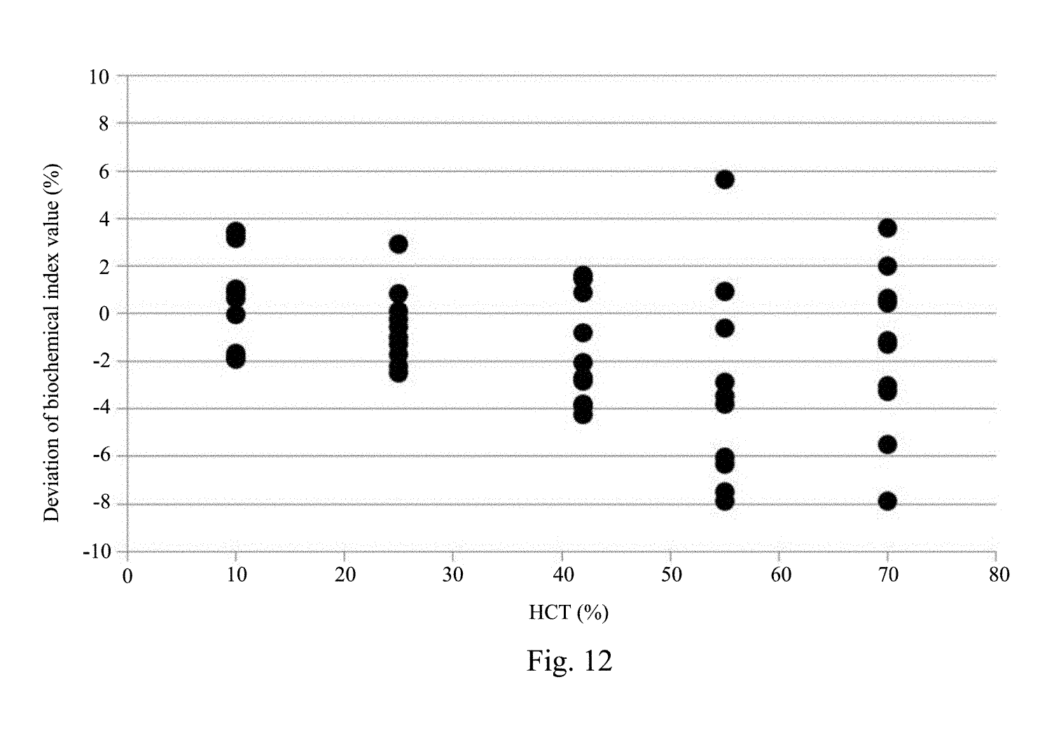

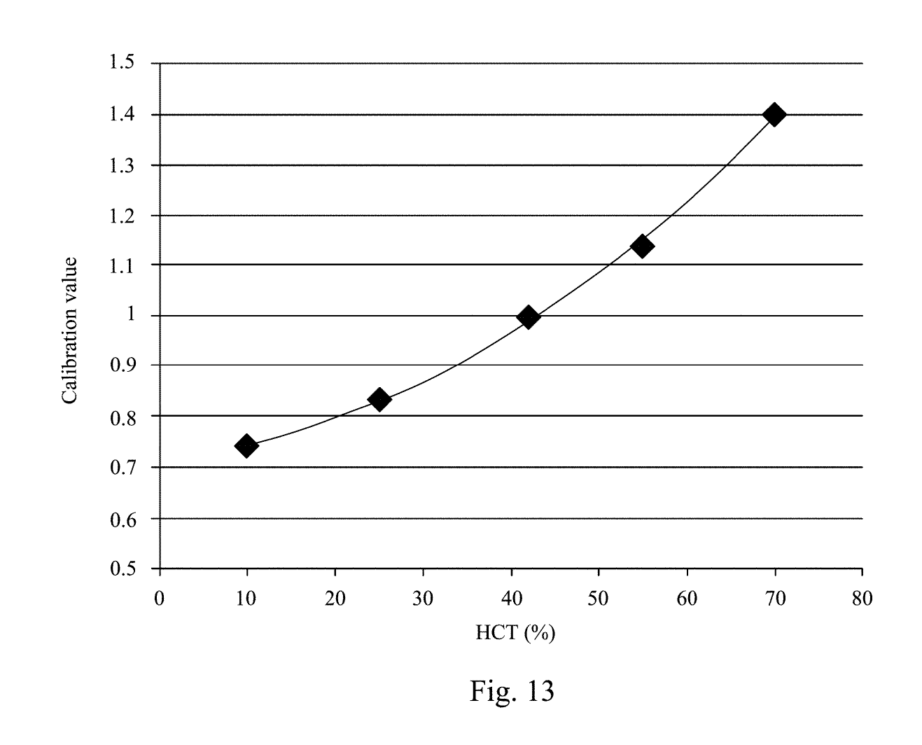

Specifically, reference is made to FIGS. 12 and 13. FIG. 12 is a deviation of biochemical index value-hematocrit test chart calibrated by the method for calibrating biochemical index value in blood. FIG. 13 is a calibration value-hematocrit curve diagram according to an embodiment of the disclosure. In the embodiment, step S207 can include: calculating the hematocrit HCT based on a standard calibration value-hematocrit relationship to obtain a calibration value; and multiplying the original biochemical index value by the calibration value. In other words, the calibration value is a multiplier ratio. In practical applications, the standard calibration value-hematocrit relationship corresponding to the applying of the specific second positive voltage can be transformed from a calibration value-hematocrit curve (as shown in FIG. 13) obtained by repeatedly experimenting, but the disclosure is not limited in this regard.

In an example of inspecting blood glucose by using the electrochemical test strip 110 (i.e., the biochemical index inspected by applying the low voltage L is the blood glucose), the electrode design of the electrochemical test strip 110 includes following conditions: a sum of a first external resistance R1 of the first electrode 112 and a second external resistance R2 of the second electrode 113 being 800 ohm; a ratio the second contact area A2 of the second electrode 113 to the first contact area A1 of the first electrode 112 being 1.0-2.0; the second contact area A2 being 0.9 mm²; the first thickness T1 of the first electrode 112 being about 15 um; and the second thickness T2 of the second electrode 113 being about 14 um.

Under the foregoing conditions of the electrode design, a hematocrit HCT can be obtained by comparing the area under the current-time curve (i.e., the quantity of electricity) corresponding to the applying of the specific second high positive voltage H2 with the standard quantity of electricity-hematocrit curve shown in FIG. 6. Afterwards, a corresponding calibration value can be calculated by substituting the obtained hematocrit HCT into the standard calibration value-hematocrit relationship (or by mapping the obtained hematocrit HCT based on the calibration value-hematocrit curve shown in FIG. 13). Finally, a product of the current value obtained by applying the low voltage L and the foregoing calibration value can be converted to a glucose concentration of whole blood (the current value and the glucose concentration of whole blood can be converted according to a linear relationship which is not described here), so that the inspected deviations of glucose concentration of whole blood under each of the hematocrits HCT can be eliminated, and the blood glucose concentrations can be calibrated within a deviation of about ±10%.

In an embodiment, steps S202-S207 can be performed by the processor 120, but the disclosure is not limited in this regard.

According to the foregoing recitations of the embodiments of the disclosure, it can be seen that the method for calculating hematocrit in blood of the disclosure can be used to precisely calculate the hematocrit in the blood sample by sequentially applying two high positive voltages and using the quantity of electricity corresponding to the period of applying the second high positive voltage. The hematocrit obtained by mapping the quantity of electricity based on the standard quantity of electricity-hematocrit curve is precise owing to the standard quantity of electricity-hematocrit curve is very linear. The method and system for calibrating biochemical index value in blood of the disclosure can be used to calibrate the inspected biochemical index value in the blood sample by using the precisely calculated hematocrit. In addition, in the system for calibrating biochemical index value in blood of the disclosure, the electrode design is simple (only two electrodes are required), the approach of applying voltages is simple (only DC voltages are applied), and the inspection time is short. The biochemical index value mentioned in the disclosure can be the blood glucose concentration or the uric acid concentration, or other biochemical index values that will be influenced by the hematocrit.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A method for calculating hematocrit in blood, comprising:
applying a blood sample to a reagent layer on an electrochemical test strip;
sequentially applying a first high positive voltage and a second high positive voltage to the blood sample, wherein the second high positive voltage is greater than the first high positive voltage, and the first high positive voltage is greater than or equal to 1.0 V;
calculating a quantity of electricity corresponding to the period of applying the second high positive voltage; and
calculating a hematocrit of the blood sample according to the quantity of electricity.

2. The method of claim 1, wherein the calculating the hematocrit according to the quantity of electricity comprises:
mapping the quantity of electricity based on a standard quantity of electricity-hematocrit curve to obtain the hematocrit.

3. The method of claim 1, wherein the first high positive voltage is 1.0-2.0 V, and the second high positive voltage is 2.4-4.0 V.

4. The method of claim 1, wherein the applying of the first high positive voltage is continuously performed for a first time period, the applying of the second high positive voltage is continuously performed for a second time period, and the second time period is greater than or equal to the first time period.

5. The method of claim 4, wherein the first time period is 0.1-1.0 second, and the second time period is 1.0-10 seconds.

6. The method of claim 4, wherein an interval period between the first time period and the second time period is 0-10 seconds.

7. A method for calibrating biochemical index value in blood, sequentially comprising:
applying a blood sample to a reagent layer on an electrochemical test strip;
applying a low voltage to the blood sample to obtain an original biochemical index value of the blood sample, wherein an absolute value of the low voltage is smaller than 1.0 V;
applying a first high positive voltage to the blood sample, wherein the first high positive voltage is greater than or equal to 1.0 V;
applying a second high positive voltage to the blood sample, wherein the second high positive voltage is greater than the first high positive voltage;
calculating a quantity of electricity corresponding to the period of applying the second high positive voltage;
calculating a hematocrit of the blood sample according to the quantity of electricity; and
calibrating the original biochemical index value according to the hematocrit.

8. The method of claim 7, wherein the calculating the hematocrit according to the quantity of electricity comprises:
mapping the quantity of electricity based on a standard quantity of electricity-hematocrit relationship to obtain the hematocrit.

9. The method of claim 7, wherein the calibrating the original biochemical index value according to the hematocrit comprises:
calculating the hematocrit based on a standard calibration value-hematocrit relationship to obtain a calibration value; and
multiplying the original biochemical index value by the calibration value.

10. The method of claim 7, wherein the absolute value of the low voltage is 0.1-0.7 V.

11. The method of claim 7, wherein a time period for which the low voltage is continuously applied is 1.0-10 seconds.

12. The method of claim 7, wherein the first high positive voltage is 1.0-2.0 V, and the second high positive voltage is 2.4-4.0 V.

13. The method of claim 7, wherein the applying of the first high positive voltage is continuously performed for a first time period, the applying of the second high positive voltage is continuously performed for a second time period, and the second time period is greater than or equal to the first time period.

14. The method of claim 13, wherein the first time period is 0.1-1.0 second, and the second time period is 1.0-10 seconds.

15. The method of claim 7, wherein an interval period between the first time period and the second time period is 0-10 seconds.

16. A system for calibrating biochemical index value in blood, comprising:
an electrochemical test strip comprising:
a substrate;
a first electrode disposed on a surface of the substrate;
a second electrode disposed on the surface; and
a reagent layer disposed on the surface and partially covering the first electrode and the second electrode; and
a processor configured to sequentially applying a low voltage to obtain an original biochemical index value of a blood sample, a first high positive voltage, and a second high positive voltage between the first electrode and the second electrode, wherein an absolute value of the low voltage is smaller than 1.0 V, the first high positive voltage is greater than or equal to 1.0 V, and the second high positive voltage is greater than the first high positive voltage,
wherein the processor is further configured to calculate a quantity of electricity corresponding to the period of applying the second high positive voltage, configured to calculate a hematocrit of the blood sample according to the quantity of electricity, and configured to calibrate the original biochemical index value according to the hematocrit.

17. The system of claim 16, wherein a sum of external resistance of the first electrode and the second electrode is 300-1500 ohm.

18. The system of claim 16, wherein a contact area between the second electrode and the reagent layer is 0.8-1.2 mm².

19. The system of claim 16, wherein the first electrode contacts the reagent layer with a first contact area, the second electrode contacts the reagent layer with a second contact area, and a ratio of the second contact area to the first contact area is 1.0-2.0.

20. The system of claim 16, wherein the thicknesses of the first electrode and the second electrode are 6-20 um.
